(19) United States
(12) Patent Application Publication
(10) Pub. No.: US 2011/0217439 A1
(43) Pub. Date: Sep. 8, 2011

(54) STEAM OVEN FOR "SOUS-VIDE" COOKING AND METHOD FOR USING SUCH OVEN

(75) Inventors: ALBERTO MORANDOTTI, BIANDRONNO (IT); LUCA BONASSI, SAN DAMIANO DI BRUGHERIO (IT)

(73) Assignee: WHIRLPOOL CORPORATION, BENTON HARBOR, MI (US)

(21) Appl. No.: 13/038,425

(22) Filed: Mar. 2, 2011

(30) Foreign Application Priority Data
Mar. 5, 2010 (EP) 10155661.1

(51) Int. Cl. A21B 1/08; A23L 1/01

(52) U.S. Cl. 426/510; 126/20

(57) ABSTRACT

A steam oven for cooking food placed in a vacuumized and sealed pouch comprises an user interface and an electronic control unit adapted to select a predetermined heating temperature on the basis of a food category chosen by the user and of a maximum predetermined load of food for each sealed pouch, and to select a heating time according to a predetermined reduction of food pathogens.

### BACKGROUND OF THE INVENTION

1. Field of the Invention

The present invention relates to a steam oven for cooking food placed in a vacuumized and sealed pouch and comprising an user interface and an electronic control unit. The present invention is also related to a method for cooking food placed in a vacuumized and sealed pouch when loaded in a steam oven.

2. Description of the Related Art

Sous-vide, French for “under vacuum”, is a food processing technology that involves the vacuum sealing of raw or partially prepared food in barrier plastic pouches, thermal processing at pasteurization temperatures and possibly chilling and storage at 0-3° C. before reconstitution and consumption.

Most researches on sous-vide cooking are dedicated to microbiological aspects; in fact legislation is moving towards the application of general food hygiene regulations and the requirement to use HACCP (hazard analysis and critical control point) principles. Sector-specific guidelines are being developed in many countries. The process steps involving heating or cooling are important as they should enhance the microbial stability of the food among other beneficial effects, such as flavour development, etc. In the heating up step usually only moderate core temperatures are obtained (typically 70° C.) which guarantees superior quality in terms of nutritional and sensorial properties, but this also implies that vegetative cells of pathogenous microorganisms may survive. The main factors which determine the microbiological safety of sous-vide products are: the intensity of heat treatment, the rapidity of cooling, the temperature reached and the control of chilled storage (temperature and time).

Some of the major microbiological hazards associated with sous-vide processing are linked to food pathogens. Vacuum packaging provides a suitable environment for Clostridium botulinum type E, which is capable of growth and toxin production at 3° C. Pathogens capable of growth at low temperatures, e.g. Listeria monocytogenes, enterotoxigenic Escherichia coli and spore-formers such as Bacillus cereus may survive an inadequate heat process and then they can grow during chilled storage of the product. Strict adherence to temperature control must therefore be mandatory for the sous-vide processor, distributor, retailer and consumer.

Moreover, any leaks in the seal and packaging material may allow post-thermal processing contamination with pathogens.

For these reasons sous-vide development has been accompanied by dire warnings from regulatory authorities.

In 1988 the Food and Drug Administration of the USA (FDA) barred sous-vide production by small establishments such as restaurants, but allowed sous-vide processing in establishments which filed a process deemed to be safe by relevant health authorities.

The recommendations of the US Food and Drug Administration (FDA) for sous-vide processing are listed below:
Sous-vide products should be produced and distributed with a HACCP approach.
In addition to HACCP, GMP (Good Manufacturing Practices) sanitation guidelines should be strictly followed.
In addition to the primary barrier of refrigeration, multiple barriers or hurdles should be incorporated into sous-vide products. Validation of the efficacy of multiple barriers should be accomplished with either inoculated pack studies or challenge studies.
Because temperature abuse is common, sous-vide processors should use time-temperature recorders to monitor a product's temperature history. Also recommended is the use of individual time-temperature integrators on each package to indicate if temperature abuse has occurred and whether a potential hazard exists.

Furthermore, the National Advisory Committee on Microbiological criteria for Foods (NACMCF, USA) recommended that sous vide producers demonstrate a process sufficient to achieve a minimum 4 log reduction for L. monocytogenes and destruction of all vegetative pathogens, while the UK Department of Health and the Australian Quarantine and Inspection Services recommended a minimum product core temperature of 70° C. during thermal processing for an intended shelf-life of 28 days at 0±3° C.

The role and importance of L. monocytogenes, a Gram positive asporogenous rod, as an agent of food-borne disease had become of major concern in recent years to the food industry as L. monocytogenes is one of the few food-borne pathogens that are capable of growth at refrigeration temperatures under anaerobic or microaerophilic conditions. One of the major concerns with sous vide products was therefore that L. monocytogenes, which is ubiquitous in environmental distribution, may survive the pasteurization process, and then grow during chilled storage of the product to infective levels. This is of particular concern in those products that may be consumed without any reheating. Clinical manifestations of listeriosi include meningitis, septicaemia, spontaneous abortion, conjuctivitis, oculoglandular listeriosis, cutaneous listeriosis, pneumonic listeriosis and cervicoglandular listeriosis.

It is clear that with all the above requirements and restrictions the so called sous-vide cooking process has not yet been adopted at home as a usual way of cooking food.

### SUMMARY OF THE INVENTION

It is therefore an object of the present invention to provide a steam domestic oven which is capable to perform a sous-vide cooking process without the above risk of pathogens contaminating the cooked food. Another object of the present invention is to provide a cooking algorithms able to guarantee the quality and safety of sous-vide processed food products.

Due to a dedicated set of cooking algorithms (well-defined combination of cooking time, temperature, and power) and a maximum quantity of food loaded in the steam oven cavity, safety and performance of food cooked in “Sous-Vide” technique is achieved for different food categories that embrace plenty different recipes.

### BRIEF DESCRIPTION OF THE DRAWINGS

Further advantages and features of an oven and cooking method according to the present invention will be clear from the detailed following description, with reference to the attached drawings in which:

FIG. 1 is a flow diagram showing the general sous vide process; and

FIG. 2 is a chart showing the lethal effect for L. monocytogenes in a whole meat muscle, in which a graphical explanation of the algorithms according to the invention is shown.

### DETAILED DESCRIPTION OF THE PREFERRED EMBODIMENTS

In order to identify the principal hazards and identify the phases (critical point) in which a specific hazard can arise, the sous-vide process and its operating phases were studied and analysed.

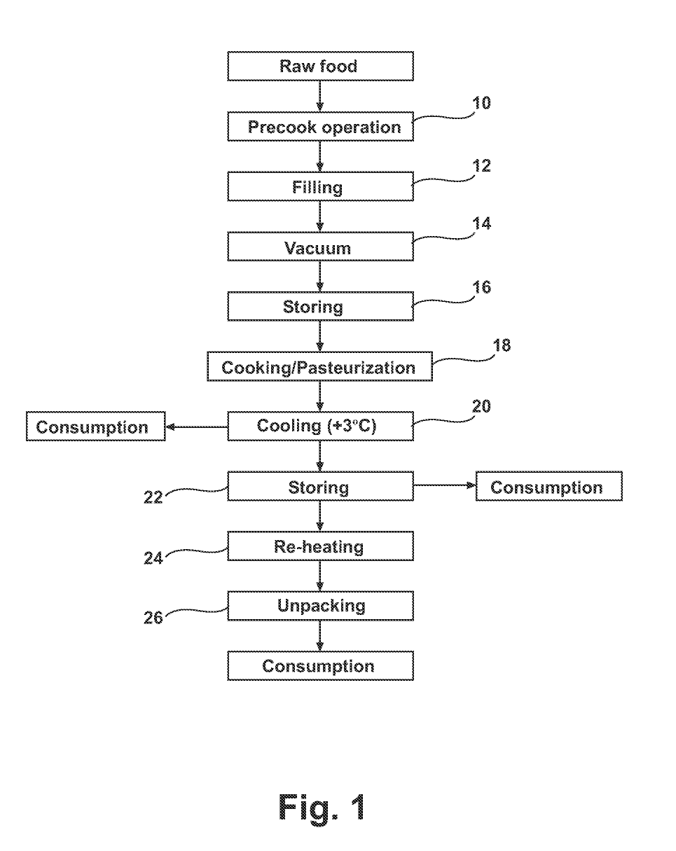

This risk analysis was conducted using the HACCP method. A food processing is represented by different steps or operations involved in the production of a food products or ready-meals. Several variables or parameters are involved in each single step. These must be controlled in order to manage the whole process and to assess the quality of the final product. The flow diagram of a representative sous-vide process is shown in FIG. 1.

In step 10 the raw food can be subjected to an optional precook operation, for instance in order to induce a Maillard reaction on the surface of a meat piece. Then in step 12 the piece of food is introduced into a shaped pouch of a barrier multilayer film. In step 14 the open portion of the pouch is heat sealed under vacuum. The storage step 16 at low temperature (around 3° C.) cannot be longer than 7 days in order to prevent an increase of pathogens. In step 18 the food is heated/cooked at a temperature usually lower than 100° C. for a predetermined time. In step 20 the pouch is quickly cooled at around 3° C. and it is ready for consumption or for storage in step 22. After storage, the pouch can be re-heated (step 24), the food can be extracted from the pouch (step 26) and it can be consumed.

From FIG. 1 it is clear that the consumption of sous-vide processed food can occur in different phases of the process. In several cases the domestic user can consume the prepared meal after cooling (+3° C.) or after storing at fridge temperature. Some food preparations can be eaten warm, thus they have to be re-heated before the consumption. This step (re-heating) can't be considered a treatment able to remove eventual microbiological contaminations.

The different phases of the process were analysed in order to identify the main hazards. In particular the risk analysis was focused on microbiological and hygienic hazard. The risk analysis was conducted by assessing, for each hazard taken into consideration and for each phase, the severity of the hazard and the probability of its occurring in a specific phase of the process.

Foodstuff has been clusterized into food categories, representative of ingredients suitable for sous vide cooking preparations.

According to gastronomy literature/chef experience three processing temperatures (95° C., 85° C. and 75° C.) have been identified and associated to the different food categories, and particularly 95° C. for a first cluster of food categories comprising creams (salty or sweet), fruits, vegetables and mollusks, 85° C. for a second cluster of food categories comprising shellfishes, fishes and poultry, and 75° C. for a third cluster of food categories including all kind of meats.

For each food category and for a predetermined maximum quantity of food loaded into a single pouch a theoretical minimum cooking time was determined. The maximum load of food that can be processed at the same time is strictly linked to the positioning of pouches on a single or double rack (4 pouches max on one rack, laying horizontally in a single layer). In order to avoid too long cooking time, a total load lower than 5600 g of food (double rack), preferably lower than 4200 g of food and more preferably around 2800 g (single rack) of a certain food placed in different pouches. For each pouch the preferred load is not higher than 700 g of food. Of course this load has to be considered as a maximum value admissible for assuring the predetermined reduction of food pathogens, and lower values can be used as well.

The calculation of the minimum cooking time is obtained from specific curves of lethality obtained through an experimental activity. The minimum cooking time value is correspondent to time necessary to reduction of 6 logarithmic unit “Listeria monocytogenes” when priory inoculated in food. This technique is widely applied in microbiological studies in order to give precisely data about safety of food, and it does not need to be fully explained here.

Following Table 1 shows food categories and related

TABLE 1

| Food category | Recipe | Cooking temperature (° C.) |
|---|---|---|
| Meat (whole muscle) | Chine | 75 |
| Poultry | Stuffed chicken | 85 |
| Fish (fillet) | Salmon | 85 |
| Mollusc | Octopus | 95 |
| Shellfish | Shrimps | 85 |
| Vegetables | Potatoes & Mushrooms | 95 |
| Fruit | Apple | 95 |
| sweet cream | Sweet cream | 95 |
| Salty cream | Salmon and cream | 95 |

cooking temperature conditions for sous-vide cooking cycles.

### Example 1

### Determination of Minimum Cooking Time

Tests were carried out by the applicant on a steam oven having a cavity of 37 litres liters and a maximum power of 1.2 kW.

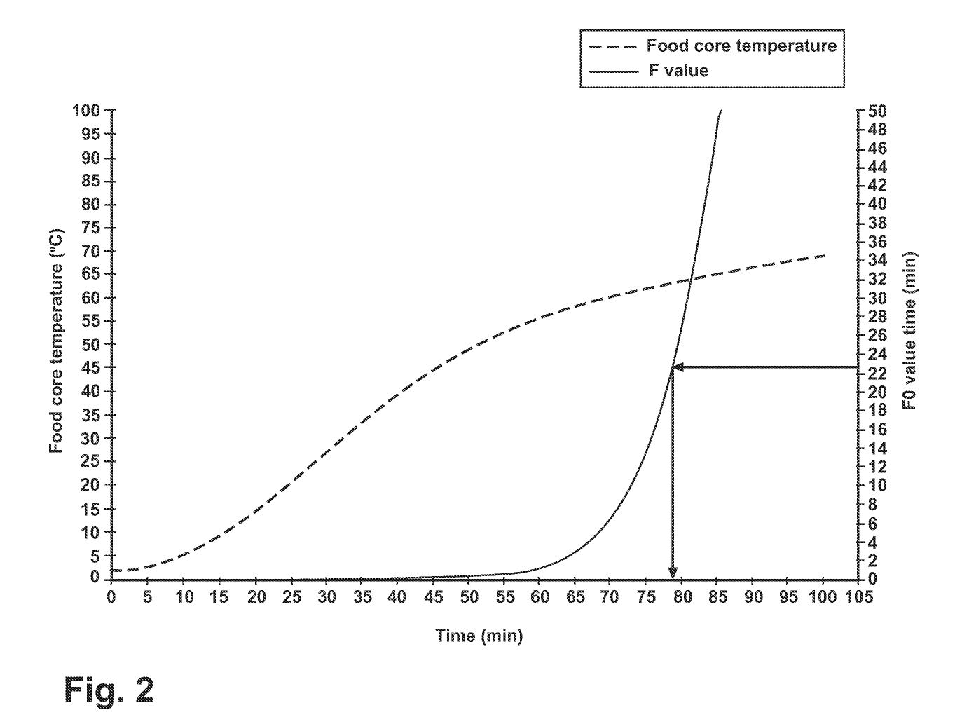

As an example of graphical use of an algorithm according to the invention, FIG. 2 shows a graphical calculation of minimum cooking time based on F value of Listeria monocytogenes in meat.

F-value is defined in units of time (minutes) and is a measure of the microbial inactivation capability of a heat sterilization process.

The F-value indicates the effect of a heat treatment, which is governed by the product heating temperature and the time during which the product is held at this temperature (product holding time). The time and temperature factors govern the ultimate effect, this effect being directly proportional to the time; triplication of the time at the relevant temperature triplicates the effect.

Other setup conditions of the experimentation:
Oven used for testing: Saturated steam oven
Temperature set: 75° C.
Food load: max possible (700 g per pouch)
Pouch number: 4 pouches on a single shelf/grid
Temperature probe: 4 different thermocouples positioned at core of each pouch (one per pouch)

In the experimentation the derived time has been exclusively calculated taking into account the slower temperature profile among four pouches so that most critical conditions were selected.

The thermal death time (TDT) or F_{T}-value is a parameter used to compare the microbial lethality induced by heat treatments. It corresponds to the time required to achieve, at a given temperature, a specified reduction in microbial number. It is quoted with suffixes indicating the heat treatment temperature and the z value (z: interval of temperature, in Celsius degrees, able to bring about a ten-fold change of the decimal reduction time, D_{T}) of the target or reference micro-organism. The F_{T}-value of lethality effect could be considered as the time needed to reduce microbial population by a multiple of the D-value according the following equation (1):

F_{T}=t·L Eq1

where L is the lethal rate and is calculated by the following equation (2):

L=10^{(T-T}^{_{ref}}^{)/z} Eq2

where T_{ref} is the reference temperature used to determine a decimal reduction time and z values of a specific bacterium.

The decimal reduction time (known as D value) is the time required at a given temperature to reduce a specific microbial population by 90% (or 1 Logarithm cycle), while z value is the temperature coefficient of microbial destruction, i.e. the increase of temperature required to achieve a tenfold change of the decimal reduction time. The decimal reduction time D and the z value are two basic parameters defining the heat resistance characteristics of single microorganisms.

And is calculated by the following equation (3):

F_{T}=t·10^{(T-T}^{_{ref}}^{)/z} Eq3

Conditions during heat treatment and thermal properties of food do not permit instantaneous temperature change in the bulk system and the equivalent lethal effect at the reference temperature need to be determined.

Among the various mathematical and graphical methods developed to determine the equivalent thermal time of a heat treatment, the following equation (4) was considered:

F=ΔtΣ10^{(T-T}^{_{ref}}^{)/z}=ΔtΣL Eq 4

The F value was, thus calculated by summation of the finite partial equivalent thermal time.

For our purpose, temperature data were acquired every 1 min (Δt=1 min), a reference temperature equal to 60° C. (T_{ref}) and a z value of 7.2° C. were considered. The latter value was chosen as referred to an alternative and pathogenic microorganism particularly thermo resistant L. monocytogenes.

In the example shown in FIG. 2, for a calculated threshold F value of 22.8 minutes, the use of the F value curve gives a minimum derived time of 79 min for meat.

An additional margin has been applied for each food category and the “minimum cooking time” has been finally defined.

The following Table 2 reports values of time estimated F from charts and “minimum cooking time” for each food category:

TABLE 2

| | | | Calculated lethal | Cooking time (min) | Cooking time (min) |
|---|---|---|---|---|---|
| Menu | Submenu | Food category | effect time (mm) | [minimum value] | [maximum value] |
| Sous Vide | Cooking SV | Meat (whole piece) | 79 | 80 | 240 |
| | | Meat (chopped or sliced) | 43 | 45 | 240 |
| | | Poultry | 43 | 45 | 240 |
| | | Fish (fillets or piece) | 38 | 40 | 240 |
| | | Mollusc | 20 | 30 | 240 |
| | | Shellfish | 22 | 28 | 240 |
| | | Vegetables | 20 | 35 | 240 |
| | | Fruit | 17 | 25 | 240 |
| | | Sweet cream | 33 | 35 | 240 |
| | | Salty cream | 19 | 30 | 240 |
| | Reheat SV | Refrigerated (+4° C.) | — | 0 | 240 |
| | | Frozen (−18° C.) | — | 0 | 240 |

If in FIG. 2 a graphical method to calculate the minimum cooking time is shown, it is clear that the using an electronic control unit of the oven, after the user has inputted the food category through the user interface of the oven, a predetermined cooking temperature stored for instance in a look up table and corresponding to a certain cluster of food categories can be chosen, and the minimum cooking time based on data of the above Table 2 for each food category can be fixed.

The above tests (used for designing Table 2) were carried out with four pouches on a single layer or shelf, identical results in terms of cooking and pathogens reduction were obtained by using up to eight pouches each containing a maximum load of 700 g of food, placed at two different levels in the steam oven cavity and avoiding an overlapping of pouches.

The cooking cycles tested by the applicant represent the best possible compromise in “Sous-Vide” cooking technique between high quality result for each recipe and safety. The customer can access this complicated technique, mostly used in industrial processing and now scaled down to domestic environment. Each algorithm according to the invention is able to provide a certain amount of heat to foodstuff in order to reach an acceptable sanity of food inside the pouch.

In order to assess real safety of food based on the experimental curves and theoretical calculation a series of microbiological test have been carried out by the applicant.

### Example 2

### Microbiological Test

The processed food was analyzed during the shelf life at different times (about every 3 days) in order to confirm the effect of the pasteurization treatment. Each condition of testing has been replicated three times.

The microbiological analyses were performed during the storage of cooked food in temperature abuse conditions (12° C.) in order to verify:
The absence of pathogens non-spore-forming such as: Aeromonas hydrophila, Listeria monocytogenes, Vibrio parahemolyticus, Salmonella spp, Staphylococcus aureus
   or
The increase or not of spore-forming bacteria such as: Clostridium butyricum, Bacillus cereus, Clostridium perfringens

Tests included many different potential factors of failure and variation, high levels of initial contamination and unusual temperature of storing.

The results of microbiological tests are reported in Table 3. The tests that gave negative results (growth of spore-forming bacteria or failure to eliminate non spore-forming bacteria) are indicated Significant (SIGN). The tests which gave positive results (absence of spore-forming or non-spore-forming bacteria) are indicated as non-significant (NON SIGN). None of the tests showed positive results as regards non spore-forming pathogenic micro-organisms; the positive results involved the tests where Clostridium butirycum and Bacillus cereus micro-organisms were used.

The tests performed on “Chine” and “Sweet cream” products never showed any positive results.

Table 3 shows that only “Potatoes & mushrooms” recipes reported significant data below 7 days storing while all others did not. These tests showed the presence of Clostridiun butyricum. Test repetition, after increasing the “minimum cooking time” to 35 min, showed negative results up to 7 days for this category.

This experimental activity was useful to assess the effectiveness of the theoretical calculation for sanity food.

TABLE 3

| | | Outcome | |
|---|---|---|---|
| Recipe | Refrigeration time (g) | NON SIGN. | SIGN. |
| Chine (whole | 3 | 36 | |
| muscle of meat) | 7 | 3 | |
| | 10 | 41 | |
| Stuffed chicken | 2 | 4 | |
| | 3 | 60 | |
| | 5 | 4 | |
| | 7 | 5 | |
| | 10 | 82 | 3 |
| Sweet cream | 6 | 12 | |
| Potatoes & | 2 | 8 | |
| Mushrooms | 3 | 52 | 2 |
| | 4 | 2 | |
| | 6 | 7 | |
| | 7 | 36 | 8 |
| | 10 | 9 | |
| Salmon | 2 | 4 | |
| | 3 | 54 | |
| | 5 | 4 | |
| | 7 | 10 | |
| | 10 | 56 | 7 |

On the basis of these results, it is possible to confirm that the cooking algorithm according to the invention is able to guarantee quality and safety of sous vide-processed food. A shelf life of 48 hours at 3° C. without loss of safety, nutritional values and weight was obtained by using a steam oven with modifications to the electronic control unit and to the user interface. The shelf-life was reported on the plastic bag as a useful indication for the domestic user.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

1. A steam oven for cooking food placed in a vacuumized and sealed pouch and comprising a user interface and an electronic control unit, characterized in that the electronic control unit is adapted to select a predetermined heating temperature on the basis of a food category chosen by the user through the user interface and of a maximum predetermined load of food, and to select a heating time according to a predetermined reduction of food pathogens.

2. The steam oven according to claim 1, wherein the electronic control unit is capable of storing different cooking temperatures each corresponding to a predetermined cluster of food categories, and different predetermined heating time each corresponding to a food category.

3. The steam oven according to claim 2, wherein the electronic control unit is capable of storing three different temperatures of 95° C., 85° C. and 75° C. corresponding to the following three clusters of food categories: a first cluster of food categories comprising creams (salty or sweet), fruits, vegetables and mollusks, a second cluster of food categories comprising shellfishes, fishes and poultry, and a third cluster of food categories including all kind of meats.

4. The steam oven according to claim 2, wherein the electronic unit is capable of storing a minimum heating time comprised between 17 and 25 minutes for fruits, a minimum heating time comprised between 22 and 28 minutes for shellfishes, a minimum heating time comprised between 19 and 30 minutes for salty creams and mollusks, a minimum heating time comprised between 20 and 35 minutes for sweet creams and vegetables, a minimum heating time comprised between 38 and 40 minutes for fishes, a minimum heating time comprised between 43 and 45 minutes for poultry and chopped or sliced meats and a minimum heating time comprised between 79 and 80 minutes for meats in a whole piece.

5. The steam oven according to claim 4, wherein the electronic unit is capable of storing a minimum heating time of about 25 minutes for fruits, a minimum heating time of about 28 minutes for shellfishes, a minimum heating time of about 30 minutes for salty creams and mollusks, a minimum heating time of about 35 minutes for sweet creams and vegetables, a minimum heating time of about 40 minutes for fishes, a minimum heating time of 45 minutes for poultry and chopped or sliced meats and a minimum heating time of about 80 minutes for meats in a whole piece.

6. The steam oven according to claim 1, wherein the oven is capable of cooking a maximum predetermined load of food that is equal or lower than 5600 g.

7. The steam oven according to claim 6, wherein the food is placed in pouch containing a load equal or lower than 700 g of food.

8. A method for cooking food placed in a vacuumized and sealed pouch and loaded in a steam oven, wherein that it comprises the following steps:
choosing a food category;
automatically selecting a predetermined heating temperature related to a cluster of food categories to which the chosen food category belongs and to a predetermined maximum amount of food, and
maintaining the food at the predetermined temperature for a predetermined time in order to achieve a predetermined reduction of food pathogens.

9. The method according to claim 8, wherein the predetermined time is assessed experimentally on the basis of a threshold F value:
F_{T}=t·10^{(T-T}^{_{ref}}^{)/z}
where T is the measured temperature inside the food contained in a vacuum pouch loaded in the oven at the predetermined heating temperature, T_{ref} is the reference temperature used to determine a decimal reduction time and z value is the temperature coefficient of microbial destruction for a predetermined pathogen.

10. The method according to claim 8, wherein the predetermined time is assessed experimentally on the basis of a threshold F value:
F=ΔtΣ10^{(T-T}^{_{ref}}^{)/z}=ΔtΣL
where T is the measured temperature inside the food contained in a vacuum pouch, T_{ref} is the reference temperature used to determine a decimal reduction time, z value is the temperature coefficient of microbial destruction for a predetermined pathogen and L is the lethal time L=10^{(T-T}^{_{ref}}^{)/z}.

11. The method according to claim 9, wherein the reference temperature is about 60° C. and z value is about 7.2° C., the reference pathogenic microorganism being L. monocytogenes.

12. The method according to claim 8, wherein the temperature is selected among three different temperatures of 95° C., 85° C. and 75° C. corresponding to the following three clusters of food categories: a first cluster of food categories comprising creams (salty or sweet), fruits, vegetables and mollusks, a second cluster of food categories comprising shellfishes, fishes and poultry, and a third cluster of food categories including all kind of meats.

13. The method according to claim 12, wherein the predetermined heating time is comprised between 17 and 25 minutes for fruits, between 22 and 28 minutes for shellfishes, between 19 and 30 minutes for salty creams and mollusks, between 20 and 35 minutes for sweet creams and vegetables, between 38 and 40 minutes for fishes, between 43 and 45 minutes for poultry and chopped or sliced meats and between 79 and 80 minutes for meats in a whole piece.

14. The method according to claim 8, wherein the predetermined maximum amount of food is equal or lower than 5600 g.

15. The method according to claim 14, wherein the maximum load of food in each pouch is equal or lower than 700 g.
